(19) United States
(12) Patent Application Publication
(10) Pub. No.: US 2013/0266724 A1
(43) Pub. Date: Oct. 10, 2013

(54) METHOD OF MANUFACTURING TOUCH SCREEN PANEL

(71) Applicant: ELECTRONICS AND TELECOMMUNICATIONS RESEARCH INSTITUTE, Daejeon (KR)

(72) Inventor: Woo-Seok CHEONG, Daejeon (KR)

(73) Assignee: Electronics and Telecommunications Research Institute, Daejeon (KR)

(21) Appl. No.: 13/717,823

(22) Filed: Dec. 18, 2012

(30) Foreign Application Priority Data
Apr. 10, 2012 (KR) 10-2012-0037149

(51) Int. Cl. G06F 3/041

(52) U.S. Cl. CPC G06F 3/041
USPC 427/97.2

(57) ABSTRACT

Provided is a method of manufacturing a touch screen panel. The method of manufacturing the touch screen panel includes preparing a substrate including a cell region and an interconnection region formed around the cell region, forming bridge electrodes arranged at a predetermined distance on the cell region of the substrate, forming an insulation layer on the substrate including the bridge electrodes, patterning the insulation layer to form contact holes exposing both ends of the bridge electrodes, and forming X-axis electrode extending in a first direction between the contact holes spaced apart from and facing each other and Y-axis electrode cells filling the contact holes and formed in a second direction perpendicular to the first direction. The bridge electrodes, the X-axis electrodes, and the Y-axis electrode cells are formed as hybrid electrodes, respectively.

### CROSS-REFERENCE TO RELATED APPLICATIONS

This U.S. non-provisional patent application claims priority under 35 U.S.C. § 119 of Korean Patent Application No. 10-2012-0037149, filed on Apr. 10, 2012, the entire contents of which are hereby incorporated by reference.

### BACKGROUND OF THE INVENTION

The present invention disclosed herein relates to a method of manufacturing a touch screen panel, and more particularly, to a method of manufacturing a window integrated type of capacitive overlay touch screen panel in which a bridge electrode and a touch panel electrode are formed as hybrid electrodes, respectively.

Recently, as electronic devices such as computers and portable communication terminals are becoming more common, touch screens are being widely used as units for inputting data. Touch screens may be classified into resistive film type touch screens, capacitive type touch screens, surface acoustic wave type touch screens, and infrared beam type touch screens.

According to the resistive film type touch screens, if a substrate is touched by a finger or pen, transparent electrodes of upper and lower substrates contact each other to generate an electrical signal. Thus, resistive film type touch screens may be devices for inputting data by grasping the touched position using the generated electrical signal. Since the resistive film type touch screens have low prices, high optical transmittance, multi touch functions, and quick speed of response, the resistive overlay touch screen may be favorable for miniaturization. Thus, the resistive film type touch screens may be mainly applied to PDAs, PMPs, navigations, headset kits, and the like.

According to the capacitive type touch screens, predetermined capacitance may be generated in an insulation layer by static electricity occurring from a finger when a substrate including a transparent electrode may be touched by the finger to contact an electric conductor. Thus, a signal may be transmitted through a portion in which the capacitance is generated to calculate an intensity of the signal, thereby grasping the touched position.

The surface acoustic wave (SAW) type touch screens may utilize a technology in which the amplitudes of the acoustic waves are reduced when the acoustic waves meet obstacles. Since the SAW type touch screens has high optical transmittance and high accuracy and definition, the SAW type touch screens may be used for automated information terminals which are installed at the outdoor spaces. However, the SAW type touch screens may have disadvantages that a sensor may be contaminated and easily affected by liquid.

The infrared beam (IR) type touch screens may utilize properties of infrared rays which that go straight and is blocked by obstacles. Also, since an indium tin oxide (ITO) film or a glass substrate is not required on a front surface of the display, such an IR type touch screen may be embodied using one sheet of glass. Thus, optical transmittance may be very superior.

The capacitive type touch screens of the various touch screens may have the multi touch functions that are the basics of emotional touch to manufacture a sensor having high optical transmittance. Thus, the capacitive type touch screens may be applicable to large-scaled and thin displays in which the emotional touch is possible.

### SUMMARY OF THE INVENTION

The present invention provides a method of manufacturing a touch screen panel having improved visibility.

The feature of the present invention is not limited to the aforesaid, but other features not described herein will be clearly understood by those skilled in the art from descriptions below.

Embodiments of the present invention provide methods of manufacturing a touch screen panel, the methods including: preparing a substrate including a cell region and an interconnection region formed around the cell region;

forming bridge electrodes arranged at a predetermined distance on the cell region of the substrate; forming an insulation layer on the substrate including the bridge electrodes; patterning the insulation layer to form contact holes exposing both ends of the bridge electrodes; and forming X-axis electrode extending in a first direction between the contact holes spaced apart from and facing each other and Y-axis electrode cells filling the contact holes and formed in a second direction perpendicular to the first direction, wherein the bridge electrodes, the X-axis electrodes, and the Y-axis electrode cells are formed as hybrid electrodes, respectively.

In some embodiments, before the insulation layer is patterned, the method may further includes forming a first buffer layer and a second buffer layer.

In other embodiments, the first buffer layer may be a transparent insulator having a high refractive index, and the second buffer layer may be a transparent insulator having a low refractive index.

In still other embodiments, each of the X-axis electrodes may include X-axis electrode cells and X-axis connection electrodes connecting the X-axis electrode cells to each other.

In even other embodiments, the X-axis electrodes and the Y-axis electrode cells may be spaced apart from each other.

In yet other embodiments, the hybrid electrode may include a lower oxide layer, a metal layer, and an upper oxide layer which are successively stacked on each other.

In further embodiments, each of the lower oxide layer and the upper oxide layer may be formed of one of ITO, IZTO, IZO, AZO, and GZO.

In still further embodiments, each of the lower oxide layer and the upper oxide layer may have a thickness of about 40 nm to about 60 nm

In even further embodiments, the metal layer may be formed of one of Ag, Ag-Al, Ag-Mo, Ag-Au, Ag-Pd, Ag-Ti, Ag-Cu, Ag-Au-PD, and Ag-Au-Cu.

In yet further embodiments, the metal layer may have a thickness of about 5 nm to about 15 nm.

In much further embodiments, after the X-axis electrodes and the Y-axis electrode cells are formed, the methods may further include forming metal interconnections on the interconnection region of the substrate.

In other embodiments of the present invention, methods of manufacturing a touch screen panel include: forming X-axis electrodes extending in a first direction and Y-axis electrode cells spaced from the X-axis electrodes and arranged in a second direction crossing the first direction on a substrate; forming an insulation layer having contact holes exposing both ends of the Y-axis electrode cells on the substrate on which the X-axis electrodes and the Y-axis electrode cells are formed; and forming bridge electrodes filling the contact holes which are spaced apart from and facing each other between the X-axis electrodes in the second direction on a top surface of the insulation layer, wherein the X-axis electrodes, the Y-axis electrode cells, and the bridge electrodes are formed as hybrid electrodes, respectively.

In some embodiments, the hybrid electrode may include a lower oxide layer, a metal layer, and an upper oxide layer which are successively stacked on each other

In other embodiments, each of the lower oxide layer and the upper oxide layer may be formed of one of ITO, IZTO, IZO, AZO, and GZO.

In still other embodiments, each of the lower oxide layer and the upper oxide layer may have a thickness of about 40 nm to about 60 nm

In even other embodiments, the metal layer may be formed of one of Ag, Ag-Al, Ag-Mo, Ag-Au, Ag-Pd, Ag-Ti, Ag-Cu, Ag-Au-PD, and Ag-Au-Cu.

In yet other embodiments, the metal layer may have a thickness of about 5 nm to about 15 nm.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIGS. 1A to 3A are plan views illustrating a process of manufacturing a touch screen panel according to an embodiment of the present invention;

FIGS. 1B to 3B are cross-sectional views taken along line A-A′ of FIGS. 1A to 3A, respectively;

FIGS. 1C to 3C are cross-sectional views taken along line B-B′ of FIGS. 1A to 3A, respectively;

FIGS. 4A to 6A are plan views illustrating a process of manufacturing a touch screen panel according to another embodiment of the present invention;

FIGS. 4B to 6B are cross-sectional views taken along line A-A′ of FIGS. 4A to 6A, respectively;

FIGS. 4C to 6C are cross-sectional views taken along line B-B′ of FIGS. 4A to 6A, respectively; and

FIG. 7 is a graph illustrating transmittance depending on a thickness of a lower oxide layer in a hydride electrode according to an embodiment of the present invention.

### DETAILED DESCRIPTION OF PREFERRED EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. In the drawings, the dimensions of layers and regions are exaggerated for clarity of illustration.

In the following description, the technical terms are used only for explain a specific exemplary embodiment while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

Additionally, the embodiment in the detailed description will be described with sectional views as ideal exemplary views of the present invention. In the figures, the dimensions of layers and regions are exaggerated for clarity of illustration. Accordingly, shapes of the exemplary views may be modified according to manufacturing techniques and/or allowable errors. Therefore, the embodiments of the present invention are not limited to the specific shape illustrated in the exemplary views, but may include other shapes that may be created according to manufacturing processes. For example, an etched region illustrated or described as a rectangle will, typically, have rounded or curved features. Thus, the regions illustrated in the figures are schematic in nature and their shapes are not intended to illustrate the precise shape of a region of a device and are not intended to limit the scope of the present invention.

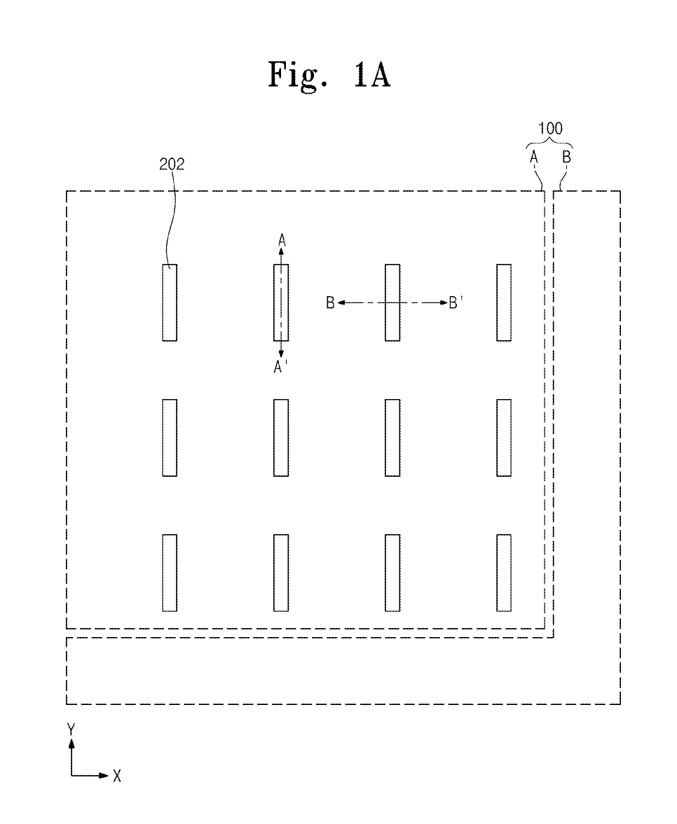

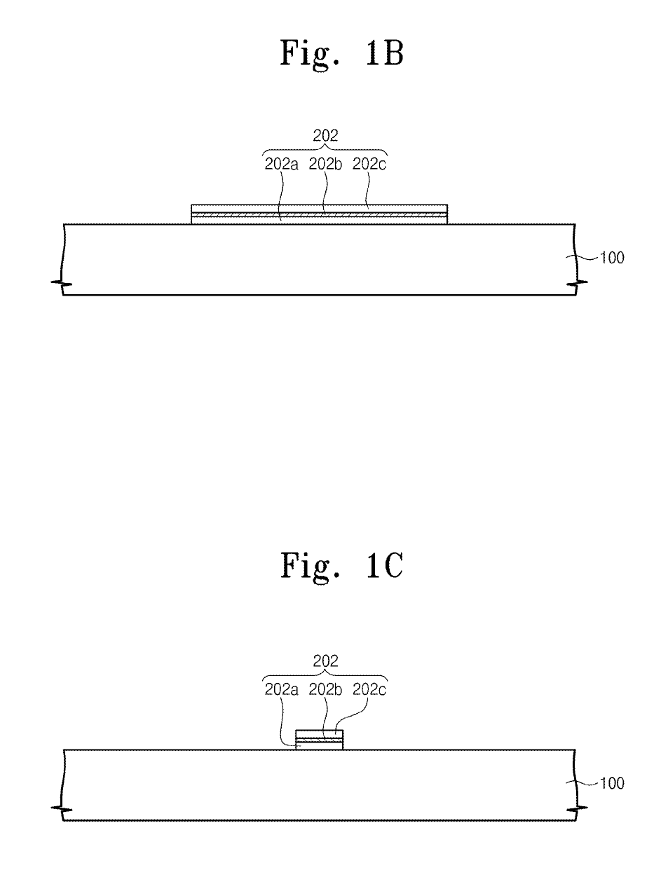

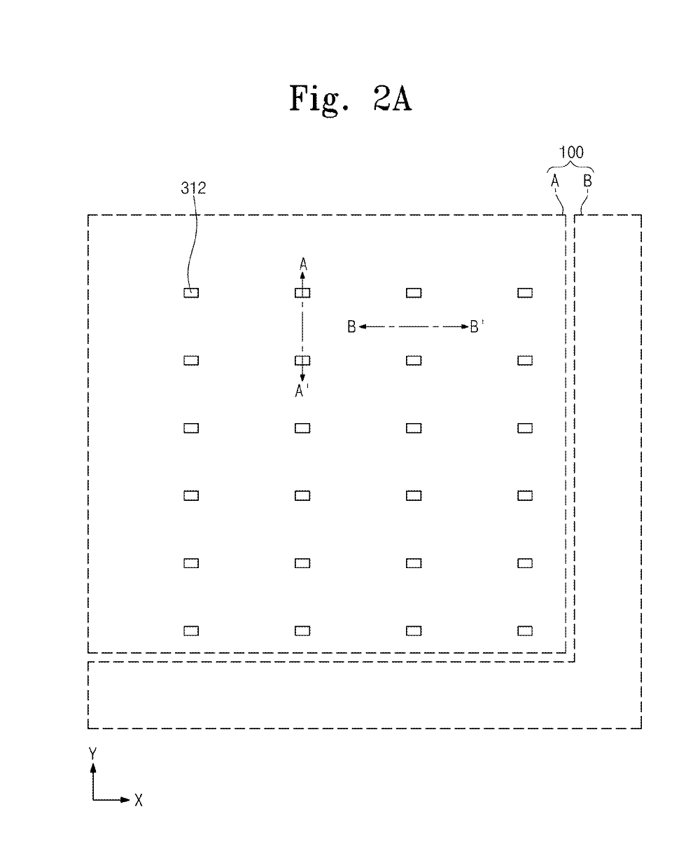

FIGS. 1A to 3A are plan views illustrating a process of manufacturing a touch screen panel according to an embodiment of the present invention. FIGS. 1B to 3B are cross-sectional views taken along line A-A′ of FIGS. 1A to 3A, respectively. FIGS. 1C to 3C are cross-sectional views taken along line B-B′ of FIGS. 1A to 3A, respectively.

Referring to FIGS. 1A to 1C, bridge electrodes 202 may be arranged at a predetermined distance on a top surface of a substrate 100.

The substrate 100 may include a cell region A and an interconnection region B defined around the cell region A. The substrate 100 may include a tempered glass substrate in which a chemical strengthening treat is performed, a reinforced plastic substrate, a polycarbonate (PC) substrate which is coated with a reinforced film, and a polyethylene terephthalate (P.E.T) substrate.

The bridge electrodes 202 may be spaced a predetermined distance from each other in a first direction (an X-axis direction) and a second direction (a Y-axis direction) on the cell region A. The bridge electrodes 202 may be formed as a hybrid electrode. A hybrid electrode layer (not shown) may be formed on a top surface of the substrate 100 and then patterned to form the bridge electrodes 202. The hybrid electrode layer (not shown) may be formed by using one of screen printing, physical vapor deposition, chemical vapor deposition, and atomic layer deposition. The hybrid electrode layer (not shown) may be patterned by using a photoresist process, a wet etching process, or a dry etching process. The bridge electrodes 202 may include a lower oxide layer 202a, a metal layer 202b, and an upper oxide layer 202c. Each of the lower oxide layer 202a and the upper oxide layer 202c may have a thickness of about 40 nm to about 60 nm Each of the lower oxide layer 202a and the upper oxide layer 202c may be formed of a transparent electrode material. The transparent electrode material may be one of ITO, IZTO, IZO, AZO, and GZO. The metal layer 202b may have a thickness of about 5 nm to about 15 nm The metal layer 202b may be formed of one of Ag, Ag-Al, Ag-Mo, Ag-Au, Ag-Pd, Ag-Ti, Ag-Cu, Ag-Au-Pd, and Ag-Au-Cu.

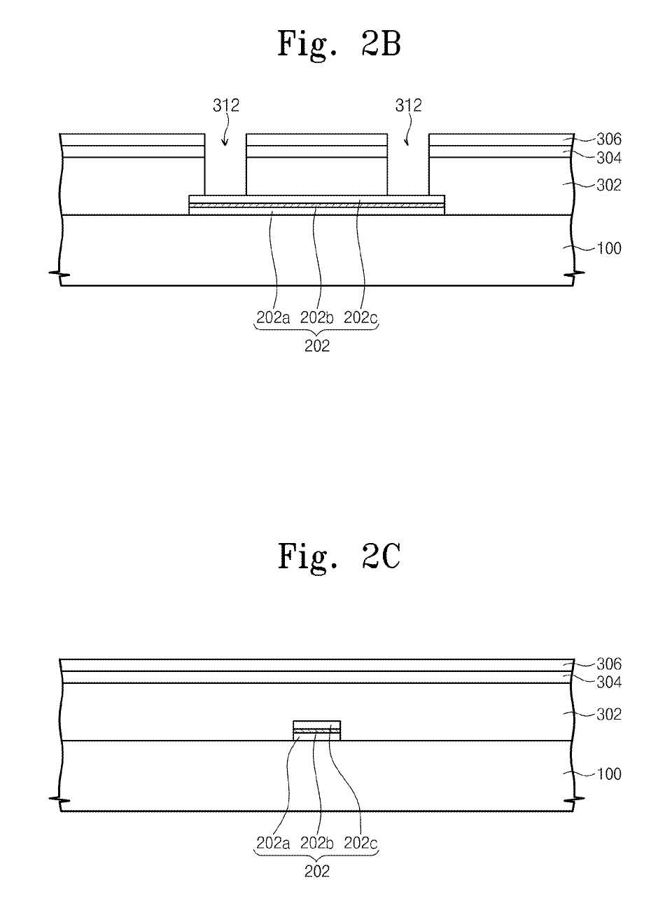

Referring to FIGS. 2A to 2C, an insulation layer 302, a first buffer layer 304, and a second buffer layer 306 may be successively formed on the substrate 100 on which the bridge electrodes 202 are formed. The insulation layer 302, the first buffer layer 304, and the second buffer layer 306 may be patterned to form contact holes 312.

The insulation layer 302 may be formed to completely cover the bridge electrodes 202. The insulation layer 302 may be formed by using one of screen printing, physical vapor deposition, chemical vapor deposition, and atomic layer deposition. The insulation layer 302 may have a thickness of about 0.1 um to about 10 um. The insulation layer 302 may be formed of SiO₂ that is a transparent insulation material.

The first buffer layer 304 may be formed on a top surface of the insulation layer 302. The first buffer layer 304 may have a thickness of about 2 nm to about 20 nm The first buffer layer 304 may be formed by using one of screen printing, physical vapor deposition, chemical vapor deposition, and atomic layer deposition. The first buffer layer 304 may be formed of an insulation material having a high refractive index. The first buffer layer 304 may be formed of a transparent insulation material having a refractive index of about 1.8 to about 2.9. The transparent insulation material may be one of TiO₂, Nb₂O₅, ZrO₂, Ta₂O₅, and HfO₂.

The second buffer layer 306 may be formed on a top surface of the first buffer layer 304. The second buffer layer 306 may have a thickness of about 20 nm to about 100 nm The second buffer layer 306 may be formed by using one of screen printing, physical vapor deposition, chemical vapor deposition, and atomic layer deposition. The second buffer layer 306 may be formed of an insulation material having a low refractive index. The second buffer layer 306 may be formed of a transparent insulation material having a refractive index of about 1.3 to about 1.8. The transparent insulation material may be one of SiO₂, SiN_{X}, MgF₂, and SiOₓN_{y}.

The contact holes 312 may be formed to expose both ends of the top surfaces of the bridge electrodes 202. The insulation layer 302, the first buffer layer 304, and the second buffer layer 306 may be patterned by using a dry etching process, a wet etching process, or a photoresist process to form the contact holes 312.

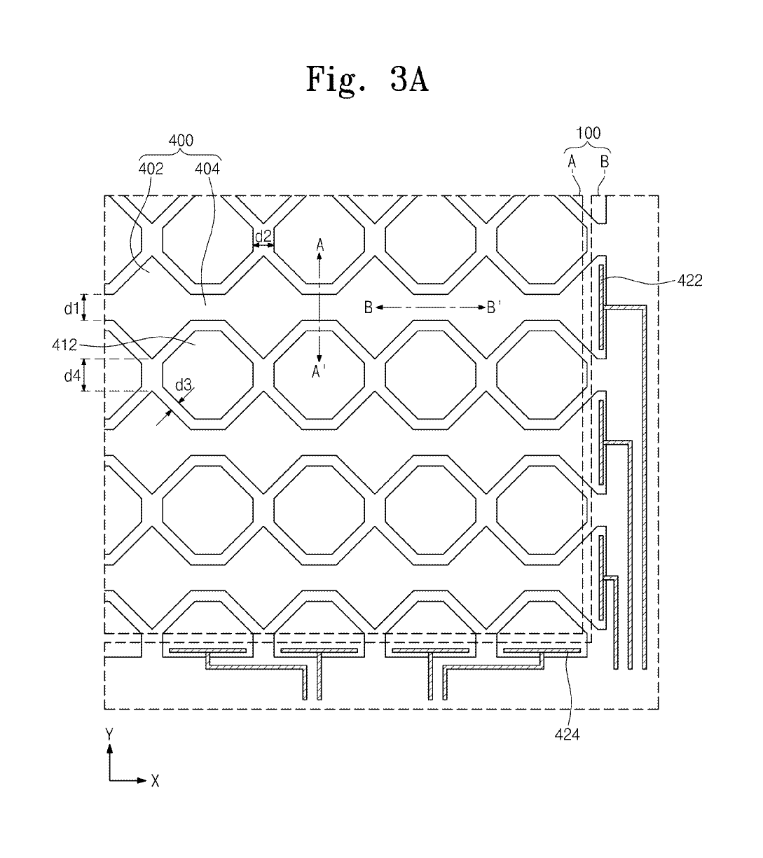

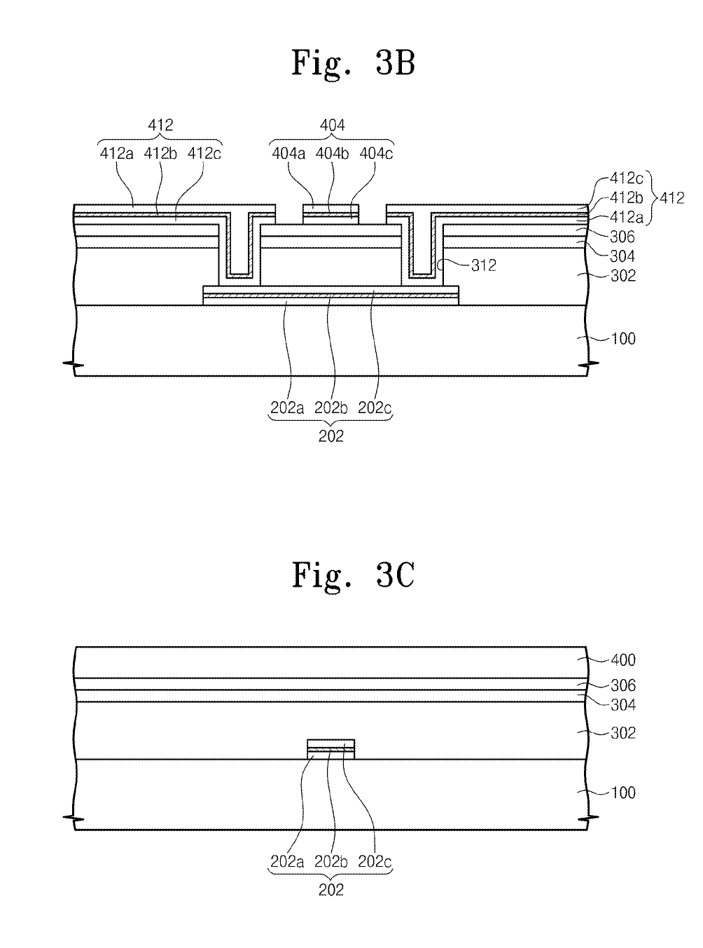

Referring to FIGS. 3A to 3C, X-axis electrodes 400 and Y-axis electrode cells 412 may be formed on the substrate 100 having the contact holes 312.

A hybrid electrode layer (not shown) may be formed on a top surface of the second buffer layer 306 and then patterned to form the X-axis electrodes 400 and the Y-axis electrode cells 412. The hybrid electrode layer (not shown) may be formed by using one of screen printing, physical vapor deposition, chemical vapor deposition, and atomic layer deposition. The hybrid electrode layer (not shown) may be patterned by using a photoresist process, a wet etching process, or a dry etching process. The X-axis electrodes 400 and the Y-axis electrode cells 412 may be formed on the cell region A.

The X-axis electrodes 400 may be formed to extend in the first direction (X-axis direction) between the contact holes 312 spaced apart from and facing each other. Each of the X-axis electrodes 400 may include X-axis electrode cells 402 and X-axis connection electrodes 404 connecting the X-axis electrode cells 402 to each other. Thus, the X-axis connection electrodes 404 may be disposed between the contact holes 312. Each of the X-axis electrode cells 402 may have a diamond shape. Thus, vertexes of the X-axis electrode cells 402 may horizontally and vertically adjacent to each other to face each other. The X-axis connection electrodes 404 may connect the vertexes of the X-axis electrode cells 402 adjacent to each other in the first direction to each other. However, the present invention is not limited thereto. For example, each of patterns of the X-axis electrode cells 402 may have a diamond shape, a rectangular shape, a square shape, or a polygonal shape.

The Y-axis electrode cells 412 may be formed in the second direction (Y-axis direction) and spaced from the X-axis electrodes 400. Also, the contact holes 312 may be filled with the Y-axis electrode cells 412. Thus, the Y-axis electrode cells 412 spaced apart from each other may contact the bridge electrodes 202 and thus be electrically connected to each other. Each of the Y-axis electrode cells 412 may have a diamond shape. However, the present invention is not limited thereto. For example, each of patterns of the Y-axis electrode cells 412 may have a diamond shape, a rectangular shape, a square shape, or a polygonal shape.

When the X-axis electrodes 400 and the Y-axis electrode cells 412 are formed, each of a width d1 of each of the X-axis connection electrodes 404 and a width d2 spaced between the Y-axis electrode cells 412 may range from 20 um to about 2,000 um. The width d2 spaced between the Y-axis electrode cells 412 may be equal to or greater than that d1 of each of the X-axis connection electrodes 404. A width d3 between the X-axis electrode cells 402 and the Y-axis electrode cells 412 which are adjacent to each other may range from about 2 um to about 2,000 um. A width d4 between the vertexes of the X-axis electrode cells 402 adjacent to each other in the second direction may range from about 10 um to about 1,000 um.

Each of the X-axis electrodes 400 and the Y-axis electrode cells 412 may be a hybrid electrode. The X-axis electrodes 400 and the Y-axis electrode cells 412 may include lower oxide layers 400a and 412a, metal layers 400b and 412b, and upper oxide layers 400c and 412c. Each of the lower oxide layers 400a and 412a and the upper oxide layers 400c and 412c may have a thickness of about 40 nm to about 60 nm Each of the lower oxide layers 400a and 412 and the upper oxide layers 400c and 412c may be formed of a transparent electrode material. The transparent electrode material may be one of ITO, IZTO, IZO, AZO, and GZO. Each of the metal layers 400b and 412b may have a thickness of about 5 nm to about 15 nm. The metal layers 400b and 412b may be formed of one of Ag, Ag-Al, Ag-Mo, Ag-Au, Ag-Pd, Ag-Ti, Ag-Cu, Ag-Au-Pd, and Ag-Au-Cu.

Metal interconnections 422 and 424 may be further formed on the interconnection region B of the substrate 100. The metal interconnections 422 and 423 may be formed with a predetermined distance therebetween. The metal interconnections 422 and 424 may include driving line metal interconnections 422 connected to the X-axis electrode cells 402 and sensing line metal interconnections 424 connected to the Y-axis electrode cells 412. Each of a distance between the driving line metal interconnections 422 and a distance between the sensing line metal interconnections 424 may range from about 20 um to about 2,000 um. The distance between the driving line metal interconnections 422 may be equal to that between the sensing line metal interconnections 424. The metal interconnections 422 and 424 may be a single and/or multilayered metal layer formed of one of Mo, Al, Cu, Cr, Ag, Ti/Cu, Ti/Ag, Cr/Ag, Cr/Cu, Al/Cu, and Mo/Al/Mo.

After the metal interconnections 422 and 424 are formed, an optical adhesive layer (not shown), a polarized film (not shown), and a liquid crystal display device (not shown) may be further formed on a lower portion of the substrate 100 to form an integrated touch screen panel.

The bridge electrodes 202 and the touch panel electrodes 400 and 412 may be formed as the hybrid electrode to improve visibility when compared to an existing touch screen panel formed of an ITO material. In addition, since the hybrid electrode includes a metal layer, a surface resistance may be reduced when compared to that of the ITO material. Thus, a large-scaled touch screen panel may be manufactured.

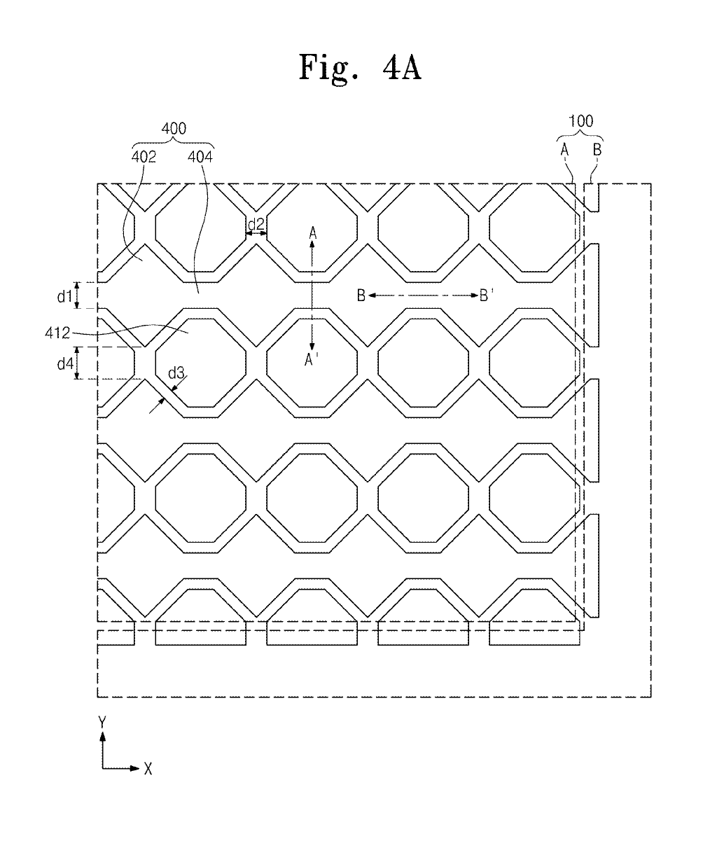

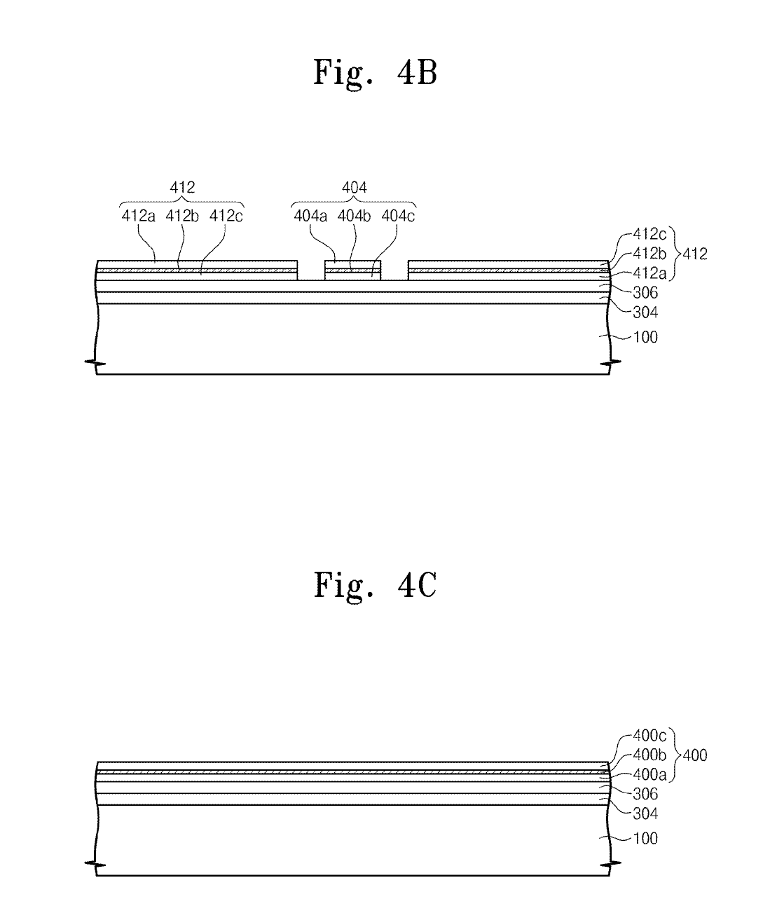

FIGS. 4A to 6A are plan views illustrating a process of manufacturing a touch screen panel according to another embodiment of the present invention. FIGS. 4B to 6B are cross-sectional views taken along line A-A′ of FIGS. 4A to 6A, respectively. FIGS. 4C to 6C are cross-sectional views taken along line B-B′ of FIGS. 4A to 6A, respectively.

Referring to FIGS. 4A to 4C, X-axis electrodes 400 and Y-axis electrode cells 412 may be formed on a substrate 100 on which a first buffer layer 304 and a second buffer layer 306 are successively formed.

The substrate 100 may include a cell region A and an interconnection region B defined around the cell region A. The substrate 100 may include a tempered glass substrate in which a chemical strengthening treat is performed, a reinforced plastic substrate, a polycarbonate(PC) substrate which is coated with a reinforced film, and a polyethylene terephthalate (P.E.T) substrate.

The first buffer layer 304 may be formed on a top surface of the substrate 100. The first buffer layer 304 may have a thickness of about 2 nm to about 20 nm The first buffer layer 304 may be formed by using one of screen printing, physical vapor deposition, chemical vapor deposition, and atomic layer deposition. The first buffer layer 304 may be formed of an insulation material having a high refractive index. The first buffer layer 304 may be formed of a transparent insulation material having a refractive index of about 1.8 to about 2.9. The transparent insulation material may be one of TiO₂, Nb₂O₅, ZrO₂, Ta₂O₅, and HfO₂.

The second buffer layer 306 may be formed on a top surface of the first buffer layer 304. The second buffer layer 306 may have a thickness of about 20 nm to about 100 nm The second buffer layer 306 may be formed by using one of screen printing, physical vapor deposition, chemical vapor deposition, and atomic layer deposition. The second buffer layer 306 may be formed of an insulation material having a low refractive index. The second buffer layer 306 may be formed of a transparent insulation material having a refractive index of about 1.3 to about 1.8. The transparent insulation material may be one of SiO₂, SiN_{X}, MgF₂, and SiOₓN_{y}.

X-axis electrodes 400 and Y-axis electrode cells 402 may be formed on a top surface of the second buffer layer 306. A hybrid electrode layer (not shown) may be formed on the top surface of the second buffer layer 306 and then patterned to form the X-axis electrodes 400 and the Y-axis electrode cells 412. The hybrid electrode layer (not shown) may be formed by using one of screen printing, physical vapor deposition, chemical vapor deposition, and atomic layer deposition.

The hybrid electrode layer (not shown) may be patterned by using a photoresist process, a wet etching process, or a dry etching process. The X-axis electrodes 400 and the Y-axis electrode cells 412 may be formed on the cell region A.

The X-axis electrodes 400 may be form to extend in a first direction (X-axis direction) on the top surface of the second buffer layer 306. Each of the X-axis electrodes 400 may include X-axis electrode cells 402 and X-axis connection electrodes 404 connecting the X-axis electrode cells 402 to each other. Each of the X-axis electrode cells 402 may have a diamond shape. Thus, vertexes of the X-axis electrode cells 402 may horizontally and vertically adjacent to each other to face each other. The X-axis connection electrodes 404 may connect the vertexes of the X-axis electrode cells 402 adjacent to each other in the first direction (X-axis direction) to each other. However, the present invention is not limited thereto. For example, each of patterns of the X-axis electrode cells 402 may have a diamond shape, a rectangular shape, a square shape, or a polygonal shape.

The Y-axis electrode cells 412 may extend in a second direction (Y-axis direction) perpendicular to the first direction on the top surface of the second buffer layer 306. Also, the Y-axis electrode cells 412 may be disposed between the X-axis connection electrodes 404 adjacent to each other without contacting the X-axis electrodes 400. Each of the Y-axis electrode cells 412 may have a diamond shape. However, the present invention is not limited thereto. For example, each of patterns of the Y-axis electrode cells 412 may have a diamond shape, a rectangular shape, a square shape, or a polygonal shape.

When the X-axis electrodes 400 and the Y-axis electrode cells 412 are form, each of a width d1 of each of the X-axis connection electrodes 404 and a width d2 spaced between the Y-axis electrode cells 412 may range from 20 um to about 2, 2000 um. The width d2 spaced between the Y-axis electrode cells 412 may be equal to or greater than that d1 of each of the X-axis connection electrodes 404. A width d3 between the X-axis electrode cells 402 and the Y-axis electrode cells 412 which are adjacent to each other may range from about 20 um to about 2,000 um. A width d4 between the vertexes of the X-axis electrode cells 402 adjacent to each other in the second direction may range from about 10 um to about 1,000 um.

Each of the X-axis electrodes 400 and the Y-axis electrode cells 412 may be formed as a hybrid electrode. The X-axis electrodes 400 and the Y-axis electrode cells 412 may include lower oxide layers 400a and 412a, metal layers 400b and 412b, and upper oxide layers 400c and 412c. Each of the lower oxide layers 400a and 412a and the upper oxide layers 400c and 412c may have a thickness of about 40 nm to about 60 nm Each of the lower oxide layers 400a and 412 and the upper oxide layers 400c and 412c may be formed of a transparent electrode material. The transparent electrode material may include one of ITO, IZTO, IZO, AZO, and GZO. Each of the metal layers 400b and 412b may have a thickness of about 5 nm to about 15 nm The metal layers 400b and 412b may be formed of one of Ag, Ag-Al, Ag-Mo, Ag-Au, Ag-Pd, Ag-Ti, Ag-Cu, Ag-Au-Pd, and Ag-Au-Cu.

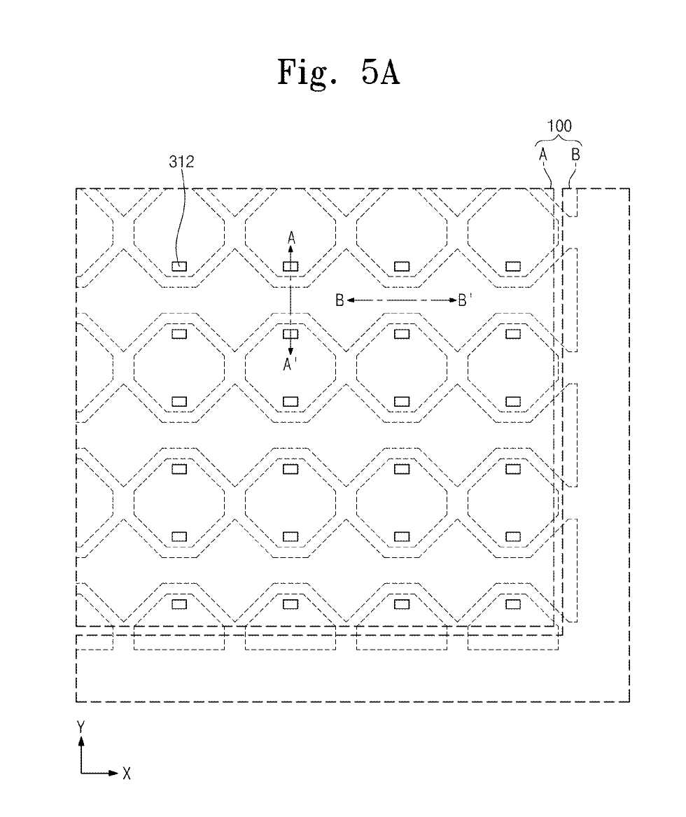

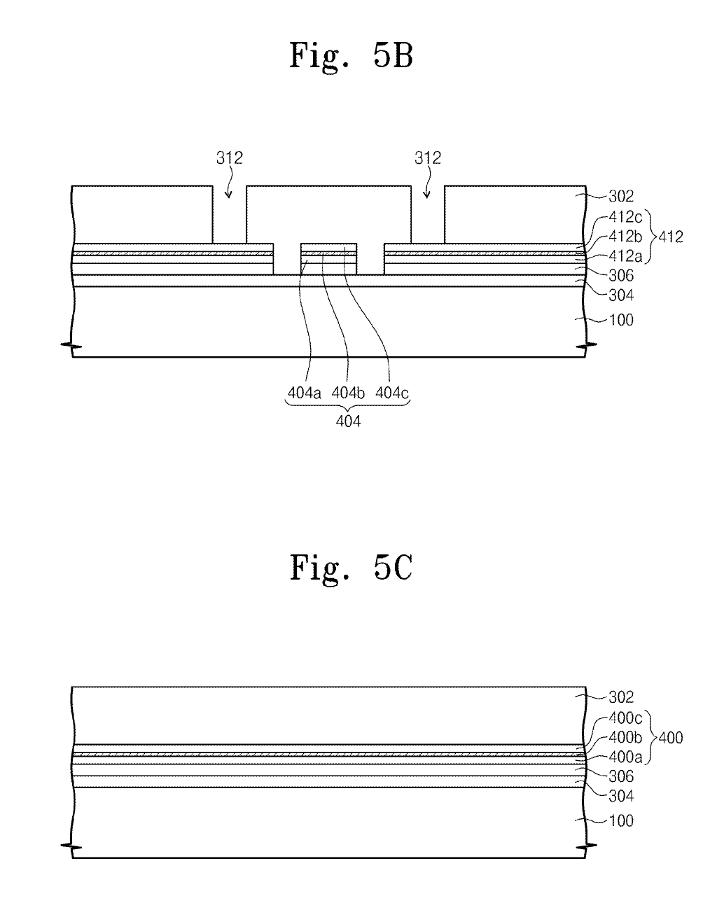

Referring to FIGS. 5A to 5C, an insulation layer 302 may be form to completely cover the X-axis electrodes 400 and the Y-axis electrode cells 412. The insulation layer 302 may be patterned to form contact holes 312 exposing both ends of top surfaces of the Y-axis electrode cells 412 in the second direction.

The insulation layer 302 may be formed by using one of screen printing, physical vapor deposition, chemical vapor deposition, and atomic layer deposition. The insulation layer 302 may have a thickness of about 0.1 um to about 10 um. The insulation layer 302 may be formed of SiO₂ that is a transparent insulation material.

The insulation layer 302 may be patterned by using a dry etching process, a wet etching process, or a photoresist process to form the contact holes 312.

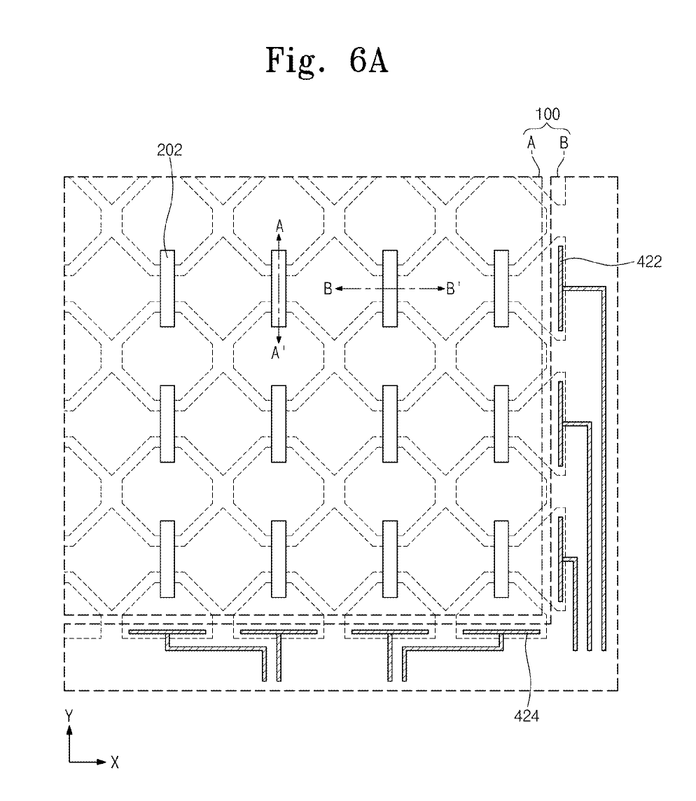

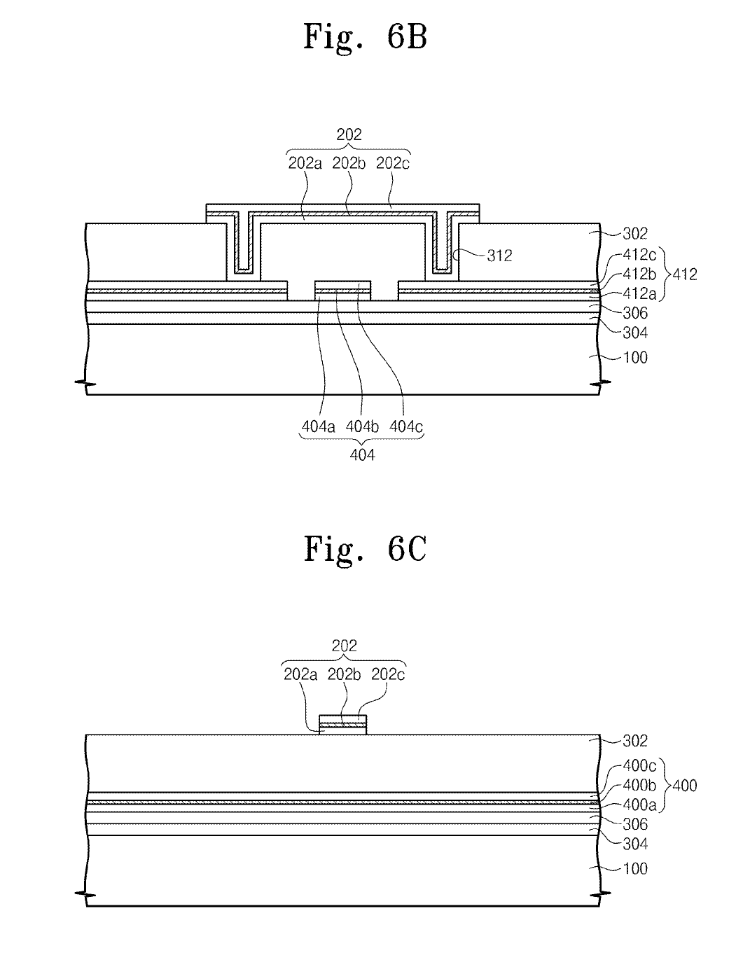

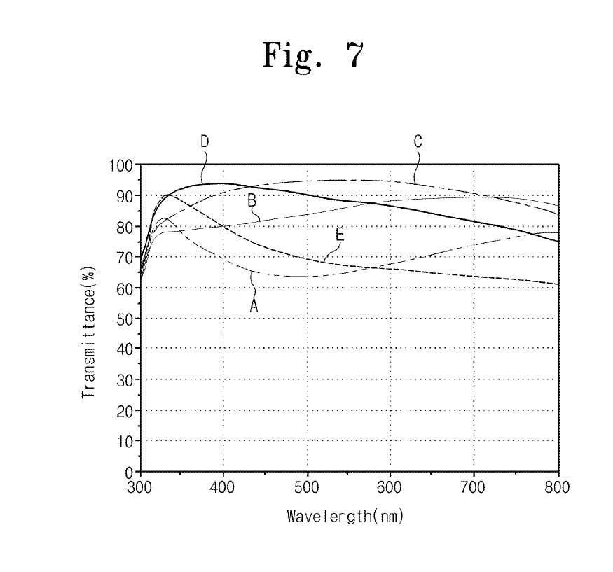

Referring to FIGS. 6A to 6C, bridge electrodes 202 may be formed on a top surface of the insulation layer 302.

The bridge electrodes 202 may fill the contact holes 312 spaced apart from and facing each other in the second direction. Also, the bridge electrodes 202 may be connected to the Y-axis electrode cells 412. In detail, each of the bridge electrodes 202 may be formed to cross on the X-axis connection electrodes 404. Thus, the Y-axis electrode cells 412 spaced apart from each other may be electrically connected to each other by the bridge electrodes 202.

The bridge electrodes 202 may be formed as a hybrid electrode, respectively. A hybrid electrode layer (not shown) may be formed on a top surface of the substrate 100 and then patterned to form the bridge electrodes 202. The hybrid electrode layer (not shown) may be formed by using one of screen printing, physical vapor deposition, chemical vapor deposition, and atomic layer deposition. The hybrid electrode layer (not shown) may be patterned by using a photoresist process, a wet etching process, or a dry etching process. The bridge electrode 202 may include a lower oxide layer 202a, a metal layer 202b, and an upper oxide layer 202c. Each of the lower oxide layer 202a and the upper oxide layer 202c may have a thickness of about 40 nm to about 60 nm. Each of the lower oxide layer 202a and the upper oxide layer 202c may be formed of a transparent electrode material. The metal layer 202b may have a thickness of about 5 nm to about 15 nm The transparent electrode material may include one of ITO, IZTO, IZO, AZO, and GZO. The metal layer 202b may be formed of one of Ag, Ag-Al, Ag-Mo, Ag-Au, Ag-Pd, Ag-Ti, Ag-Cu, Ag-Au-Pd, and Ag-Au-Cu.

Metal interconnections 422 and 424 may be further formed on the interconnection region B of the substrate 100. The metal interconnections 422 and 424 may be formed with a predetermined distance therebetween. The metal interconnections 422 and 423 may include driving line metal interconnections 422 connected to the X-axis electrode cells 402 and sensing line metal interconnections 424 connected to the Y-axis electrode cells 412. Each of a distance between the driving line metal interconnections 422 and a distance between the sensing line metal interconnections 424 may range from about 20 um to about 2,000 um. The distance between the driving line metal interconnections 422 may be equal to that between the sensing line metal interconnections 424. The metal interconnections 422 and 424 may be a single and/or multilayered metal layer formed of one of Mo, Al, Cu, Cr, Ag, Ti/Cu, Ti/Ag, Cr/Ag, Cr/Cu, Al/Cu, and Mo/Al/Mo.

After the metal interconnections 422 and 424 are formed, an optical adhesive layer (not shown), a polarized film (not shown), and a liquid crystal display device (not shown) may be further formed on a lower portion of the substrate 100 to form an integrated touch screen panel.

FIG. 7 is a graph illustrating optical transmittance depending on a thickness of a lower oxide in a hydride electrode according to an embodiment of the present invention.

When the lower oxide layer has a thickness of about 40 nm to about 60 nm, visibility of the touch screen panel may be improved.

Referring to FIG. 7, the hybrid electrode may have a thickness corresponding to the sum of a thickness (t) of the lower oxide layer, a thickness (about 100 Å) of the metal layer, and a thickness (about 900 Å-t) of the upper oxide layer. The metal layer may be formed of Ag (silver). The lines A, B, C, D, and E represent optical transmittance curves in case where the lower oxide layer has thicknesses of about 100 Å, about 300 Å, about 450 Å, about 600 Å, and about 800 Å, respectively. Comparing the transmittance curves, it may be seen that the transmittance is above about 80% within a visible light wavelength band of about 380 nm to about 780 nm.

In the method of manufacturing the touch screen panel according to the embodiments of the present invention, the bridge electrodes and the touch panel electrodes can be formed as the hybrid electrode. Thus, the visibility can be improved when compared to a touch screen panel in which each of a bridge electrode and a touch panel electrode are formed of an ITO material. Also, since the hybrid electrode material has a surface resistance less than that of the ITO material, a large-scaled touch screen panel can be manufactured.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of manufacturing a touch screen panel, the method comprising:
preparing a substrate comprising a cell region and an interconnection region formed around the cell region;
forming bridge electrodes arranged at a predetermined distance on the cell region of the substrate;
forming an insulation layer on the substrate comprising the bridge electrodes;
patterning the insulation layer to form contact holes exposing both ends of the bridge electrodes; and
forming X-axis electrodes extending in a first direction between the contact holes spaced apart from and facing each other and Y-axis electrode cells filling the contact holes and formed in a second direction perpendicular to the first direction,
wherein the bridge electrodes, the X-axis electrodes, and the Y-axis electrode cells are formed as hybrid electrodes, respectively.

2. The method of claim 1, before the insulation layer is patterned, further comprising forming a first buffer layer and a second buffer layer.

3. The method of claim 2, wherein the first buffer layer is a transparent insulator having a high refractive index, and the second buffer layer is a transparent insulator having a low refractive index.

4. The method of claim 1, wherein each of the X-axis electrodes comprises X-axis electrode cells and X-axis connection electrodes connecting the X-axis electrode cells to each other.

5. The method of claim 1, wherein the X-axis electrodes and the Y-axis electrode cells are spaced apart from each other.

6. The method of claim 1, wherein the hybrid electrode comprises a lower oxide layer, a metal layer, and an upper oxide layer which are successively stacked on each other.

7. The method of claim 6, wherein each of the lower oxide layer and the upper oxide layer is formed of one of ITO, IZTO, IZO, AZO, and GZO.

8. The method of claim 7, wherein each of the lower oxide layer and the upper oxide layer has a thickness of about 40 nm to about 60 nm.

9. The method of claim 6, wherein the metal layer is formed of one of Ag, Ag-Al, Ag-Mo, Ag-Au, Ag-Pd, Ag-Ti, Ag-Cu, Ag-Au-PD, and Ag-Au-Cu.

10. The method of claim 9, wherein the metal layer has a thickness of about 5 nm to about 15 nm.

11. The method of claim 1, after the X-axis electrodes and the Y-axis electrode cells are formed, further comprising forming metal interconnections on the interconnection region of the substrate.

12. A method of manufacturing a touch screen panel, the method comprising:
forming X-axis electrodes extending in a first direction and Y-axis electrode cells spaced from the X-axis electrodes and arranged in a second direction crossing the first direction on a substrate;
forming an insulation layer having contact holes exposing both ends of the Y-axis electrode cells on the substrate on which the X-axis electrodes and the Y-axis electrode cells are formed; and
forming bridge electrodes filling the contact holes which are spaced apart from and facing each other between the X-axis electrodes in the second direction on a top surface of the insulation layer,
wherein the X-axis electrodes, the Y-axis electrode cells, and the bridge electrodes are formed as hybrid electrodes, respectively.

13. The method of claim 12, wherein the hybrid electrode comprises a lower oxide layer, a metal layer, and an upper oxide layer which are successively stacked on each other.

14. The method of claim 13, wherein each of the lower oxide layer and the upper oxide layer is formed of one of ITO, IZTO, IZO, AZO, and GZO.

15. The method of claim 14, wherein each of the lower oxide layer and the upper oxide layer has a thickness of about 40 nm to about 60 nm

16. The method of claim 13, wherein the metal layer is formed of one of Ag, Ag-Al, Ag-Mo, Ag-Au, Ag-Pd, Ag-Ti, Ag-Cu, Ag-Au-PD, and Ag-Au-Cu.

17. The method of claim 16, wherein the metal layer has a thickness of about 5 nm to about 15 nm.
